(19) United States
(12) Patent Application Publication
(10) Pub. No.: US 2014/0027516 A1
(43) Pub. Date: Jan. 30, 2014

(54) Color Extension of Barcodes

(71) Applicant: Ikko Fushiki, Sunnyvale, CA (US)

(72) Inventor: Ikko Fushiki, Sunnyvale, CA (US)

(21) Appl. No.: 13/950,048

(22) Filed: Jul. 24, 2013

Related U.S. Application Data
(60) Provisional application No. 61/675,010, filed on Jul. 24, 2012.

(51) Int. Cl. G06K 19/06; G06K 7/14

(52) U.S. Cl. CPC G06K 19/0614; G06K 7/1408
USPC 235/462.04; 235/494

(57) ABSTRACT

A method for color extension of bar codes includes converting the white portions of a plurality of black and white bar codes to a color unique to each bar code; merging the converted bar codes together to form a combined color image; and producing a color bar code from the combined color image. The method may include rendering, scanning, and decoding the color bar code to recreate the black and white bar codes. The contents of the black and white bar codes may be utilized as data to store text, graphics commands, or music.

### RELATED APPLICATIONS

This application claims the benefit of the filing date of U.S. patent application Ser. No. 61/675,010, filed Jul. 24, 2012, which is incorporated herein by reference in its entirety.

### BACKGROUND OF THE INVENTION

The present invention generally relates to package marking, and more specifically to color extension of barcodes.

Barcodes such as Universal Price Codes (UPCs or UPC codes) and Quick Response Codes (QR codes) were created to obtain the name of a product or other inventory information by simple barcode readers that are often found in grocery stores. Only the black and white information was used in those barcodes in order to be used by simple scanning devices. The barcodes utilize the black and white pixels to encode data in a way that can be easily scanned. The barcodes in a UPC code appear as a series of alternating black and white stripes, and the barcodes in a QR code appear as a rectangular array of small squares, where each square is either black or white, with registration areas in 3 corners.

With the creation of new mobile devices and their applications, the owners of mobile devices can scan bar codes through their mobile cameras with full colors. Hence, barcodes need not be limited to black and white.

A standard computer can show 256̂3=16,777,216 colors, and hence, the extension of barcodes to the color space may enhance its information capacity significantly.

It would be desirable to have a method for combining two or more black and white bar codes into a single multi-colored code, and then recreating the original black and white codes from the single colored bar code.

### SUMMARY OF THE INVENTION

In one aspect of the present invention, a method for color extension of bar codes includes converting the white portions of a plurality of black and white bar codes to a color unique to each bar code; merging the converted bar codes together to form a combined color image; and producing a color bar code from the combined color image.

In another aspect of the present invention, a method utilizing first and second bar codes includes representing the first bar code as a first black and white image; representing the second bar code as a second black and white image; providing a color image; for each first pixel in the first black and white image, identifying a corresponding second pixel in the second bar image, combining the corresponding first and second pixels to provide a third pixel which is a color-encoding of the two black and white pixels, and storing the third pixel as a corresponding third pixel in the color image, thereby providing a color bar code that combines the first and second bar codes.

### BRIEF DESCRIPTION OF THE DRAWINGS

FIG. 1 depicts an example UPC code;

FIG. 2 depicts an example QR code;

FIG. 3 depicts an embodiment of the present invention;

FIG. 4 depicts an example of a histogram for the intensity of the red color component of a combined color image in an embodiment of the present invention;

FIG. 5 depicts an example of a graphic produced by an embodiment of the present invention;

FIG. 6 depicts an example of a 3D graphic produced by an embodiment of the present invention;

FIG. 7 depicts an example of an animation produced by an embodiment of the present invention; and

FIG. 8 depicts an example of music produced by an embodiment of the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a method for combining two or more black and white bar codes into a single multi-colored code, and then recreating the original black and white codes from the single colored bar code.

In an embodiment of the present invention, the white parts of the original two bar codes are converted to first and second colors, respectively. By overlaying the two images, one can create a combined bar code with four colors. The four colors effectively may become identifiers that can be later separated to recreate the original bar codes.

In additional embodiments, one or more of the barcodes may encode data that includes commands for graphics, animations, or music. With an embodiment of color extension of barcodes, one can have more information in barcodes. Barcodes are small in size but one can embed full scale graphics in them. Embodiments may use vector graphics instead of bitmap graphics. Graphics commands can be encoded as text in barcodes.

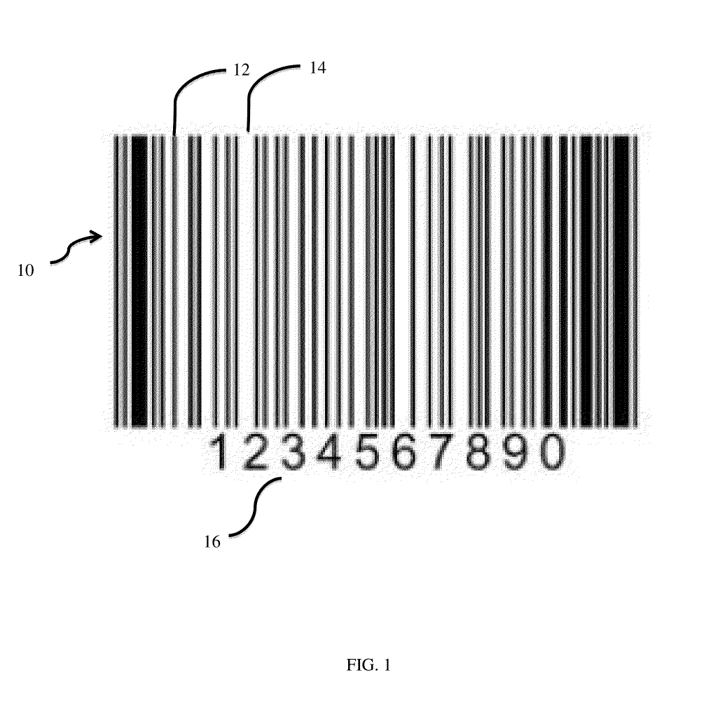

FIG. 1 depicts an example standard UPC code. The code image 10 may include black bars 12 separated by white bars 14 that represent the encoded data. A text area 16 near the bottom of the UPC code image 10 may depict the unencoded data as human-readable numerals.

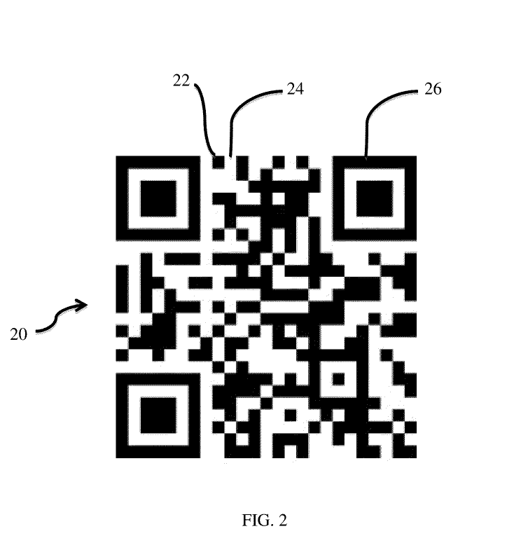

FIG. 2 depicts an example standard QR code. The code image 20 may include black squares 22 and white squares 24 that represent the encoded data. The QR code image 20 may include registration areas 26 in three corners.

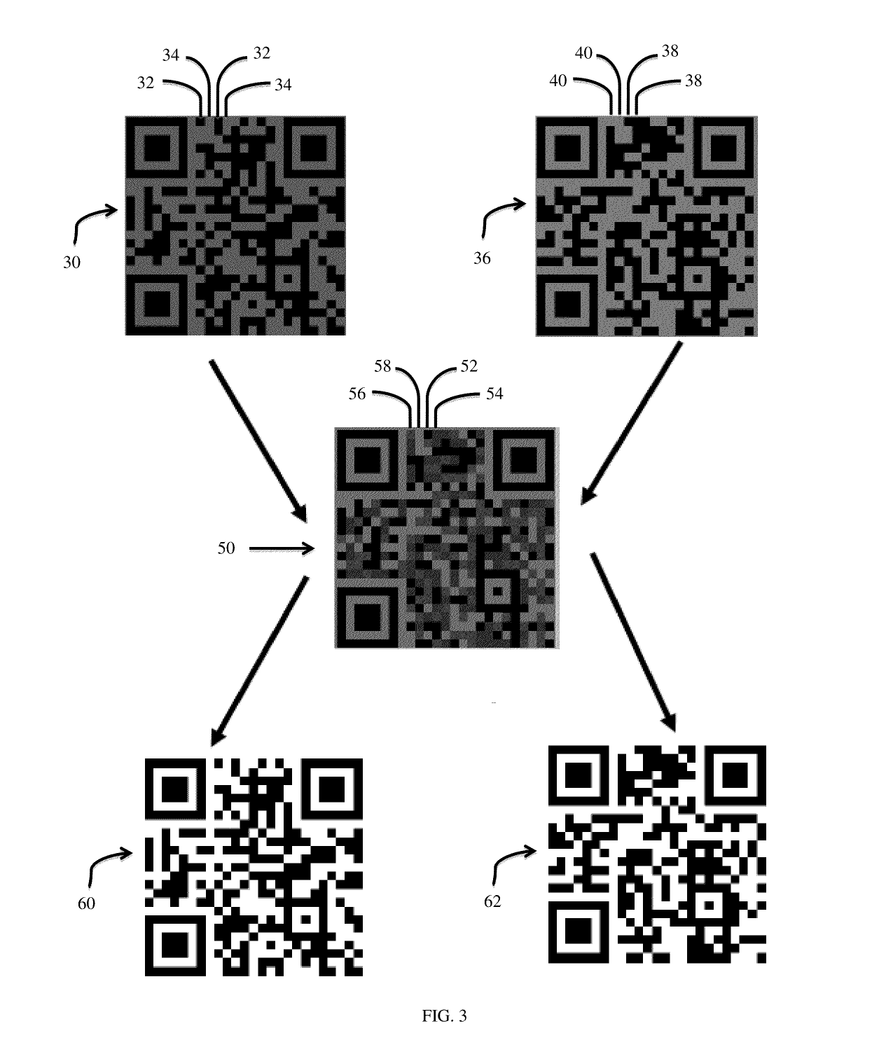

As depicted in the example embodiment of FIG. 3, the white parts of two original QR codes may be colored to red and green, respectively, as an initial step in combining the images. In the depicted example, a first code image 30 may include a plurality of black portions 32 and white portions 34 which are changed to red for combination. The data structures which represent the codes need not literally be changed in color, so long as the programming of the analysis results in a combination that reflects said coloring. For a QR code image, the portions are squares, and for a UPC code image, the portions would be bars or stripes. A second code image 36 may also contain black portions 38 and white portions 40 which are changed to green for combination. First code 30 may have a different pattern of black & white portions 32, 34 from the pattern of second code 32 black & white portions 38, 40, but the portions can be made to align with each other in a one-to-one correspondence for analysis, and registration areas in 3 corners may be generally identical and can be used to register and align the codes with each other for analysis.

The two color-changed images 30, 36 may then be combined to create a combined code 50 with four colors. In the depicted example, black portions 52 appears when both original QR codes are black. Red portions 54 appears when the first original QR code is white (changed to red) and the second original QR code is black (red+black=red). Green portions 56 appear when the second original QR code is white and the first original QR code is black (green+black=green). Yellow portions 58 appear when both original QR codes are white (red+green=yellow). By following those rules, the original black and white QR codes 60 and 62 can be recreated from the combined colored QR code when the code image is scanned.

The black and white bar codes may be represented as images that consist of pixels, which in turn may be stored in a computer memory as an array of integer values. Corresponding pixels in two or more images would be pixels that overlay each other, given that the images were registered and aligned with each other. If stored as arrays, corresponding pixels might be elements having the same index. The “pixels” are not necessarily the fine pixels produced on screens or printers, but may be the values of data encoded in the bar code. The images may be printed onto a medium, such as a sticker, or permanently rendered onto a product to indicate the bar code. In the case of QR codes, the “pixels” could correspond to the squares of black and white dots laid out in a grid.

An embodiment for combining 3 bar codes could utilize colors such as red, green and blue to encode the original bar codes, which would result in 8 colors in the combined code image (e.g. black, red, blue, green, purple, yellow, cyan, and white). Yet another embodiment might combine 4 images to create a 16-color combined code, if the scanner that scans the combined code image is capable of accurately differentiating all 16 colors. The black portions of each original image would remain black, and the white portions of each image would be converted to separate and distinguishable colors before combination so that the resulting combination image can be decoded to recreate the original images.

Embodiments of an algorithm for combining the colors could pre-color the white areas to colors and then use simple OR-ing of the bits that describe the colors, and the combined image could be separated by masking the bits. In another algorithm, the combined colors may be selected from a table to create colors that can be scanned to decode the original images. The white portions of each black and white bar code can be converted to a color unique to that bar code. This step may include replacing the white portions in place in a portion of memory, or to a temporary image or buffer with the modified coloring.

Embodiments of a procedure are not limited to combining two barcodes and are not necessarily limited to any particular color spaces. One barcode needs 2 colors. An embodiment with n-barcodes would required 2̂n colors for the combined image. Therefore, 2 barcodes would require 4 colors, and 3 barcodes would require 8 colors in the combined image. The actual number of usable colors would depend upon the quality and resolution of the scanning devices in order to recover the original barcodes from the combined image.

An embodiment with n-barcodes has 2̂n possible states for each pixel, so each pixel can be represented by a binary number of n bits. The bits of each pixel can be grouped for three colors, where the groups of bits represent RGB components for the pixel and each RGB component utilizes n/3 bits. Since we are dealing with integer numbers, the length of each binary value would be [(n+2)/3] where [ ] is the Gauss symbol indicating that [x] is the greatest integer that is less than or equal to x. For each RGB component, there are 2̂[(n+2)/3] possible states. The relation between the shade level N, in each component and the number of encoded barcodes , n, is given as N=2̂[(n+2)/3]. Reversing this relation, one can obtain a range of values for the original number of barcodes, n, as [(n+2)/3]=log_{—}2(N).

It is desirable to determine the number of original barcode images that have been combined to produce the color-extended image. After taking the histograms of a combined color barcode, the components of the colors used would be known, and this could be converted into binary representation. By combining all three components, the complete binary code for the corresponding color can be determined. This binary code would indicate which barcode is on or off at each spatial location (x, y) of the color barcode. One color barcode could be decomposed into n-original barcodes. In order to determine how many barcodes were used to create a combined image using 3 colors for the original images, histograms for each of the 3 color components in the combined image may be taken.

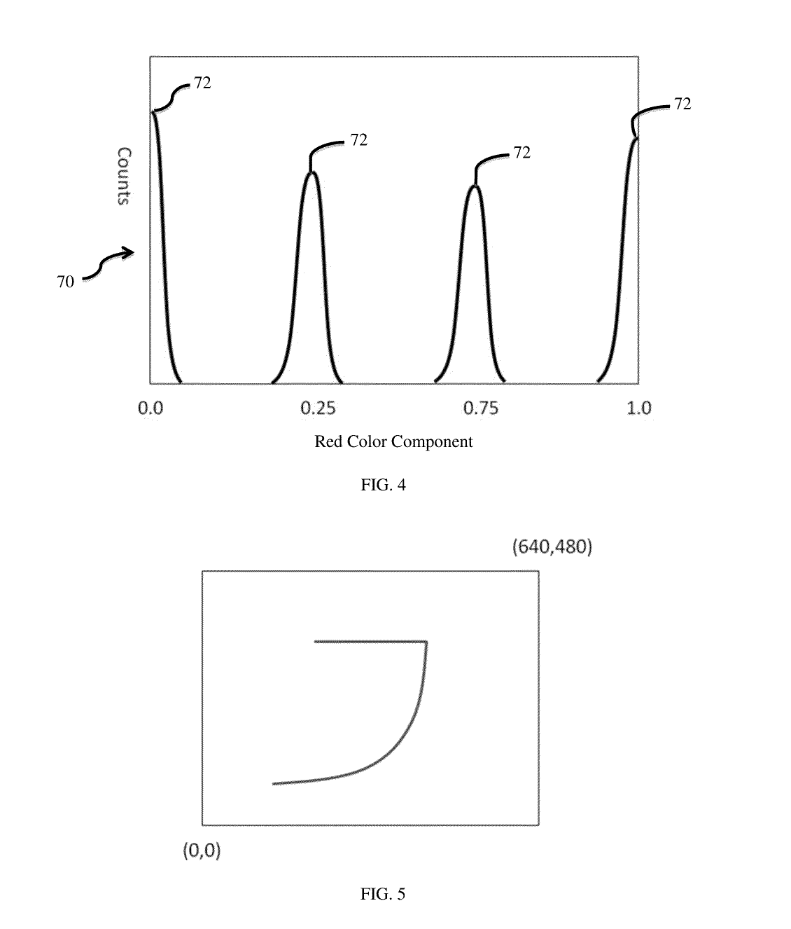

FIG. 4 is an example of a histogram 70 for the red component of a combined image, which indicates how many pixels have the indicated values of red intensity (e.g. 0.0=no red, 1.0=pure red). The example graph shows that pixels in the combined image are grouped into 4 peaks 72 appear in 4 shades of red, with slightly more zero red-intensity pixels that any other intensity. If N=4 (4 bits used to encode the red color component in the combined image), there would be n=4, 5, or 6 original bar code images. In case of n=4, or 5, some peaks are missing in the histogram of other components, because there would be a limited number of occurrences of these other colors. In case of n=6, all peaks in the histogram of all components should be present. For example, if the R-histogram had four peaks, the G-histogram had three peaks, and the B-histogram had four peaks, there would be 5 original bar codes. When n is a multiple of 3, all three histograms have the same number of peaks.

Depending upon the colors selected for the combined color bar code, it may be difficult to determine how may original barcodes (n) are stored and related to each other in the color barcode. An embodiment may allocate one additional barcode as the header barcode that describes the barcode properties and provides instructions for the original n barcodes. Hence, the embodiment will encode (n+1) barcodes with one bar code as a header. As an example, the binary data with the lowest bit set on for all color components can be designated as the header barcode.

The original plurality of black and white bar codes, which are merged to form a combined color image, may represent bits of data. Color extended bar codes may be used to store information for a variety of examples.

FIG. 5 depicts an example of a graphic produced by an embodiment of the present invention. Barcodes are small in size but we can embed full scale graphics in them. Embodiments may use vector graphics instead of bitmap graphics. An embodiment of a barcode graphic might include <G BB(0,0:640,480) M(100,100) C(300,100) C(400,200) C(400,300) L(200,300) S(1.0,0,0)/G>. The section enclosed between <G and/G> contains graphics commands. BB( ) is the bounding box. M( ) is move to, C( ) is curve to, and L( ) is line to, and S( ) is Stroke the path with specified RGB color with 1.0 with the maximum color value. When there are four numbers in S( ), the color will be interpreted as ARGB with the first component as alpha channel. As shown in FIG. 5, graphic is not restricted to the spatial dimension of the barcode. In an embodiment, the transform, line width, line style, etc, can be added. Embodiments may encode bitmap images or a reference link to an image file.

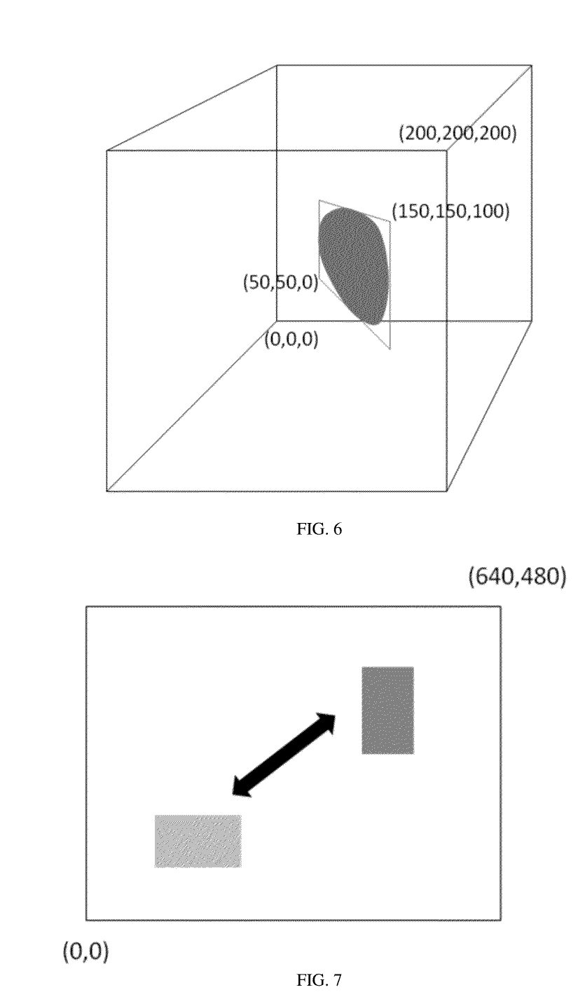

FIG. 6 depicts an example of a 3D graphic produced by an embodiment of the present invention. In embodiments, graphics commands in color-extended bar codes are not limited to 2D graphics. An embodiment of 3D graphics commands may include <G BB(0,0,0:200,200,200) E(50,50,0:150,150,150) F(0,1.0,0)/G>. BB( )in this case is the 3D bounding box. E( ) is the ellipse with the two corners of the enclosing rectangle, and F( ) is Fill the path with the specified RGB color with 1.0 with the maximum color value. When there are four numbers in F( ), the color may be interpreted as ARGB with the first component as alpha channel. An embodiment may render these graphics codes as shown in FIG. 6.

FIG. 7 depicts an example of an animation produced by an embodiment of the present invention. Graphics commands may provide a time component in addition to coordinates. Hence, one can have an animation as <G BB(0,0:640,480) T(0.0) R(100,100:250,200) F(0.8,0.5,0.0) T(2.0) R(400,400:500,550) F(0.2,0.2,1.0) LP(0.0:2.0:RV)/G>. T( ) is the time in seconds. R( ) is the rectangle. LP(0.0:2.0:RV) means the animation loops between t=0.0 state and t=2.0 state. RV means the time is reversed when it reaches 2.0 and is reversed again when it reaches 0.0. This animation will repeat forever between t=0.0 state and t=2.0 state. Without an RV flag, the animation will loop back to t=0.0 state when the time reaches 2.0. The shape, location, and color will animate smoothly. The increment of the transition can be specified in other parameters. An embodiment may render these graphics codes as shown in FIG. 7.

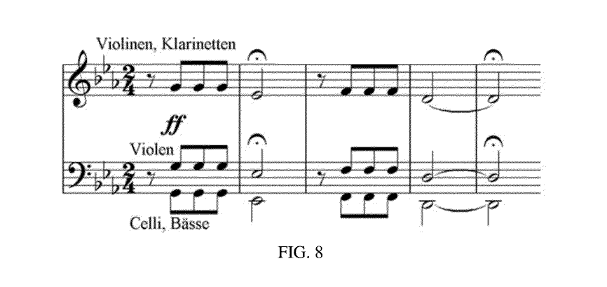

FIG. 8 depicts an example of music produced by an embodiment of the present invention. Embodiments may add music. Sound commands can be encoded as text in barcodes. For an example, <5 I(0) TP(108) T(0.0) R(0.5) G(5:0.5) G(5:0.5) G(5:0.5) Eb(5:2.0) R(0.5) F(5:0.5) F(5:0.5) F(5:0.5) D(5:4.0)/S>. In an embodiment, I( ) is the index of the instrument. One can preset a list of instrument such as 0 as Grand Piano. One can also redefine the instruments in another <S/S> code. T( ) is the starting time as in the case of the graphics codes. TP( ) is the tempo in units of beats per minute, just like the conventional music notation. R( ) indicates a rest in unit of beats. C, Db, D, . . . , Gb, G, Ab, A, Bb, B represent the musical notes. The first number in the bracket represents an octave, and the second number is the length of the note in unit of beats. The middle C is set to octave of 5. The middle and lower parts of the notes in FIG. 8 can be added as: <S T(0.0) R(0.5) G(4:0.5) G(4:0.5) G(4:0.5) Eb(4:2.0) R(0.5) F(4:0.5) F(4:0.5) F(4:0.5) D(4:4.0)/S> and <S T(0.0) R(0.5) G(3:0.5) G(3:0.5) G(3:0.5) Eb(3:2.0) R(0.5) F(3:0.5) F(3:0.5) F(3:0.5) D(3:4.0)/S>. I( ) and TP( ) commands are omitted since they are the same as the first code. This code represents the beginning of Beethoven's 5th symphony as shown in FIG. 8.

In embodiments, the pitches of notes in MIDI are defined as 60 for the middle C. In each half note, the pitch goes up 1 and goes down 1. Instead of using C, Db, . . . , one can use pitch command. For an example C(5:0.5) can be implemented as P(60:0.5) . Using the pitch has an advantage. One can express the pitch bend as follows. For an example, the pitch goes up from the middle C to the middle D in one beat duration, one can express it as: P(60,62:1.0).

The volume of the sound can be implemented as V( ) command with range 0 to 1.0. Also the volume change can be implemented as: V(1.0,0.5:4.0). That means the volume goes down from the full volume (1.0) to the half volume (0.5) in 4 beats. The recorded sound data can be implemented as the data command inside of the sound codes. Also it can be the reference link to the sound file. Multiple graphics and sound commands may be added and synchronized.

Embodiments of this barcode may be electronically transmitted, sent by email, placed in the labels, placed in the greeting cards, and used in advertisements. This barcode enables the user to see graphics and listen to music.

Embodiments of color barcode technology may increase the capacity of barcodes significantly. Currently, only texts are recorded in barcode. Embodiments may allow people to include full fidelity graphics and sound. Combined with the capacity increase storage space with color-extension, it is possible to encode the full graphics, music, and long texts in a small area of the color barcodes.

Embodiments may include a separation gap. In standard PC color, each R, G, B color is represented in 256 values. However, when a color image is taken, it can be difficult to differentiate color values which are different only by 1. It is not practical to assume you can differentiate 256 color levels. Instead, one can assume the camera can differentiate values separated by some gap. For an example, we encode 0, 16, 32, 64, . . . , 255 with 16 or 15 value gap and one can assume the camera can tell the difference with that gap.

In embodiments, when combining n-black and white barcodes, one can the description of the relation and order of the original n-black and white barcodes, and encode the description and encoding method as an extra header barcode. Then one can encode (n+1) black and white barcodes to a color barcode. A method may enable reading of the header barcode to retrieve the information of the encoding and description of the remaining n-barcodes. The on and off state of (n+1) black and white barcodes can be described in (n+1) bits of binary number.

An embodiment of a method for color extension of black and white bar codes, each bar code having a black portion and a white portion, may include: converting the white portion of a first image to a first color; converting the white portion of a second image to a second color; and creating a third image that overlays the first image with the second image, thereby providing a combined bar code with color extension.

Another embodiment of a method for color extension of black and white bar codes, each bar code having a black portion and a white portion may include encoding (n+1) black and white barcodes including a header barcode to a color barcode; splitting an (n+1)-digits binary into 3 RGB components; encoding each binary as the component color with appropriate separation gap; and recoding RGB component as a pixel data in the color barcode.

Yet another method for decoding of color barcode into multiple black and white bar codes may include analyzing a histogram of color barcode; converting the histogram data into binary representation; interpreting the binary representation to on and off state of n-black and white barcodes; interpreting one of barcodes as the header to understand the relation of other barcodes; interpreting the codes inside of the barcode; and displaying text, draw graphics, play music, go to the liked site, etc. Embodiments may be sent by email, placed in the labels, and placed in greeting cards, place in magazines, and used in advertisements, the method enabling: the user to see graphics and music in emails, labels, greeting cards, magazines, advertisement materials. Compression or encryption may be added to the barcode data to reduce the size or increase the security.

I claim:

1. A method for color extension of bar codes, comprising:
converting the white portions of a plurality of black and white bar codes to a color unique to each bar code;
merging the converted bar codes together to form a combined color image; and
producing a color bar code from the combined color image.

5. The method of claim 1, further comprising:
selecting the unique colors for each of the plurality of black and white images to have red, green, and blue (RGB) intensities that provide substantial color separation so as to distinguish each color that forms the combined color image.

6. The method of claim 1, further comprising:
rendering the combined color bar code on a permanent medium to provide a rendered bar code;
scanning the rendered bar code to provide a scanned color image; and
decoding the scanned color image to recreate the plurality of black and white bar codes.

7. The method of claim 1, further comprising:
rendering and then scanning the combined color image to provide a scanned color image;
identifying a histogram for the occurrence count for pixels having intensities of each red, green, and blue (RGB) color component that appear in the scanned color image; and
counting the number of peaks produced in the histograms, thereby identifying the number of the plurality of black and white bar codes.

8. The method of claim 1, further comprising:
selecting the unique colors for each of the plurality of black and white images to have red, green, and blue (RGB) intensities that provide substantial color separation;
rendering the combined color image on a permanent medium as a rendered bar code;
scanning the rendered bar code to provide a scanned color image;
identifying a histogram for the occurrence count for pixels having intensities of each red, green, and blue (RGB) color component that appear in the scanned color image; and
counting the number of peaks produced in the histograms, thereby identifying the number of the plurality of black and white bar codes, and using this number to recreate the plurality of black and white bar codes.

9. The method of claim 1, further comprising:
providing a header bar code to be merged with the plurality of black and white bar codes, the header bar code having header information that includes the number of the plurality of black and a white bar codes.

10. The method of claim 1, further comprising:
utilizing the contents of the black and white bar codes as data to store text.

11. The method of claim 1, further comprising:
utilizing the contents of the black and white bar codes as data to store graphics commands.

12. The method of claim 1, further comprising:
utilizing the contents of the black and white bar codes as data to store music.

13. A method utilizing first and second bar codes, the method comprising:
representing the first bar code as a first black and white image;
representing the second bar code as a second black and white image;
providing a color image;
for each first pixel in the first black and white image,
identifying a corresponding second pixel in the second bar image,
combining the corresponding first and second pixels to provide a third pixel which is a color-encoding of the two black and white pixels, and
storing the third pixel as a corresponding third pixel in the color image,
thereby providing a color bar code that combines the first and second bar codes.

13. The method of claim 13 wherein the first black and white image, the second black and white image, and the color image have the same number of pixels and the same dimensions.

14. The method of claim 13, further comprising:
rendering the color bar code on a permanent medium;
scanning the permanent medium to provide a second color image; and
decoding the second color image to recreate the first and second black and white images.
